(19) United States
(12) Patent Application Publication
(10) Pub. No.: US 2009/0168034 A1
(43) Pub. Date: Jul. 2, 2009

(54) Methods and Apparatus of Manufacturing a Semiconductor Device

(76) Inventors: Jens Staecker, Dresden (DE); Patrick Lomtscher, Tiefenbach OT Marbach (DE)

Correspondence Address: SLATER & MATSIL, L.L.P., 17950 PRESTON ROAD, SUITE 1000, DALLAS, TX, 75252, US

(21) Appl. No.: 11/966,978

(22) Filed: Dec. 28, 2007

(51) Int. Cl. G03B 27/42

(52) U.S. Cl. 355/46

(57) ABSTRACT

Methods and apparatus of manufacturing a semiconductor device are provided. Embodiments regard producing a first pattern in a first layer of a semiconductor substrate, producing a second pattern in a second layer of the semiconductor substrate, and matching the first pattern and the second pattern. The matching includes determining a mismatch between the first pattern and the second pattern that would occur without the matching and precorrecting the mismatch in the first layer.

### TECHNICAL FIELD

Embodiments of the present invention generally relate to the manufacturing of semiconductor devices. More particularly, embodiments relate to overlay control within photolithography.

### BACKGROUND

In semiconductor manufacturing, a photoresist pattern is produced by imaging a reticle pattern on a photoresist and developing the photoresist. Thereafter, etching is conducted to transfer the photoresist pattern to the underlying layer. These steps are repeated multiple times to produce a multi-layer semiconductor device.

To properly align different layers of a multi-layer semiconductor device, the overlay between different layers needs to be tightly controlled. Such overlay control is becoming even more critical as the critical dimension of semiconductor structures decreases and pattern density increases.

There is thus a general desire to provide for an overlay control.

### BRIEF DESCRIPTION OF THE DRAWINGS

The drawings show different exemplary embodiments and are not to be interpreted to limit the scope of the invention.

FIG. 1 shows a table identifying an exemplary process layer sequence and the used lithographic tool type;

FIG. 2 schematically shows a sequence of exposure fields in an uncorrected process layer sequence according to FIG. 1;

FIG. 3 schematically shows a sequence of exposure fields in a corrected process layer sequence according to FIG. 1; and

FIG. 4 schematically shows an apparatus for the manufacturing of a semiconductor device that includes a scanner system and a stepper system.

### DETAILED DESCRIPTION OF ILLUSTRATIVE EMBODIMENTS

The figures show exemplary embodiments of methods and apparatus that provide for an overlay control in a photolithographic process layer sequence using both a scanner system and a stepper system.

A stepper or stepper system is generally known to pass light through a reticle in order to form an image of the reticle pattern on a photoresist. As the stepper moves from one die of a wafer to another, each die is exposed with the desired reticle pattern.

A scanner, also referred to as a stepper and scanner or a step-and-scan system, is generally known to expose a slit of an exposure field by moving a reticle stage and a wafer stage of the scanner system in opposite directions. Generally, this technique is beneficial in improving the minimal feature size. Also, the optical properties of the projection lens of the scanner and other field parameters may be optimized during an exposure shot in the area through which the image of the exposure slit passes.

Dependent on the requirements of the processing specification, either a stepper or a scanner is used to produce a photoresist pattern, i.e., one or several of the layers of a multi-layer semiconductor device are produced using a stepper and one or several other ones of the layers of a multi-layer semiconductor device are produced using a scanner. As a stepper is a less expensive tool compared to a scanner, it is advantageous to use a stepper when the imaging requirements of the respective layer are uncritical, i.e., if the feature size that can be provided by a stepper is sufficient to produce the pattern to be implemented in that layer.

However, an overlay control problem between two or more layers may arise out of the fact that the layers are produced using different tools, i.e., stepper systems and scanner systems.

When aligning two layers, a plurality of parameters needs to be matched and, eventually, corrected to avoid overlay errors. These parameters regard interfield parameters and intrafield parameters. Interfield parameters are parameters that may be corrected by processes regarding the wafer such as a three-dimensional movement or a temperature control of the wafer. These parameters are “interfield” in that they do not regard a particular exposure field but all exposure fields on the wafer. Intrafield parameters are parameters that regard a particular exposure field or shot. Intrafield parameters are not wafer-related but are field-related. They may thus not be adjusted by a movement or manipulation of the wafer. Accordingly, interfield parameters are wafer parameters and intrafield parameters are field parameters.

Interfield parameters are wafer expansion x/y, wafer translation x/y, wafer rotation and wafer non-orthogonality.

The term “x/y” denotes that there is a value in the x-direction and a value in the y-direction such that “x/y” is an abbreviation for two parameters. A parameter “x/y” is mathematically equivalent to a symmetric component and an asymmetric component of the parameter. For example, wafer translation x/y is equivalent to a (symmetric) wafer translation and an asymmetric wafer translation. Both parameter sets are used in this description.

Wafer expansion x/y, also referred to as wafer magnification x/y, regards an increase in distance between adjacent exposure fields towards the edge of the wafer. A reason for such distortion of the wafer towards its edge may be heating of the wafer during exposure. Wafer translation x/y regards the lateral offset of all exposure fields of the wafer in the x- and y-directions compared to corresponding patterns of a previous layer. Wafer rotation regards the rotation of all exposure fields of the wafer compared to corresponding patterns of a previous layer. Wafer non-orthogonality regards an asymmetric rotation of exposure fields of the wafer compared to a previous layer. The parameters mentioned above amount to a total of six parameters.

Intrafield parameters are field magnification x/y and field rotation x/y or (symmetric) field magnification and asymmetric field magnification and (symmetric) field rotation and asymmetric field rotation. Field magnification x/y regards the expansion or reduction of an exposure field of the wafer compared to the corresponding pattern of a previous layer in the x- and y-directions. Field rotation x/y regards a rotational offset of an exposure field of the wafer compared to the corresponding pattern of a previous layer in the x- and y-directions. While correction of the two parameters “field magnification x/y” allows for correction of an asymmetric field magnification in the x- and y-directions, this is not the case for the single parameter “field magnification.” Similarly, while correction of the two parameters “field rotation x/y” allows for correction of an asymmetric field rotation in the x- and y-directions, this is not the case for the single parameter “field rotation.”

When aligning a layer that is produced using a scanner and a layer that is produced using a stepper, particular drawbacks of the used systems have to be taken into account.

For example, steppers can only correct eight of the ten parameters discussed above. These parameters are wafer expansion x/y, wafer translation x/y, wafer rotation, wafer non-orthogonality, field magnification and field rotation. On the other hand, scanners may correct ten parameters. Additional to the eight parameters that a stepper can correct, a scanner can correct the parameters of asymmetric field magnification (or field magnification x/y) and asymmetric field rotation (or field rotation x/y). In addition to the ten parameter model, some scanner systems are able to correct intrafield third order distortion and linear rotation as well. Intrafield third order distortion regards an asymmetric magnification in one direction.

Accordingly, stepper systems are not able to correct the field parameters “asymmetric field magnification” and “asymmetric field rotation.” This may lead to an overlay problem in that a scanner can only correct the mean of field magnification x/y and field rotation x/y of a previous scanner. In addition, there may be an additionally introduced field magnification since the stepper itself has a difference in field magnification due to its lens.

The reason that steppers cannot correct asymmetric field errors to improve overlay is the lack of dynamic options during imaging. Scanners, on the other hand, can correct asymmetric field errors, e.g., by changing the synchronization between the moving reticle and the wafer stage during a scan. Also, scanners may adjust one or several lens parameters during a scan to correct asymmetric field errors.

Therefore, when matching a pattern produced by a scanner system to a pattern produced by a stepper system, a problem may be caused by asymmetric field errors that may not be corrected by the stepper system. More generally, overlay errors may occur when patterns in different layers are produced using different photolithographic techniques with different characteristics.

Embodiments of the invention provide for a precorrection of a mismatch between a first pattern produced in a first layer of a semiconductor substrate and a second pattern produced in a second (later produced) layer of the semiconductor substrate. The precorrection is implemented in the first layer. Accordingly, overlay errors that would occur in the second layer are premeasured or precalculated and then precorrected already in the first layer. For example, if the first pattern in the first layer is produced using a scanner and the second pattern in the second layer is produced using a stepper, the error produced by the stepper is anticipated and corrected by the scanner in the first layer such that the respective patterns in the first and second layers will be aligned. In one aspect of the invention, accordingly, overlay correction is transferred to a more powerful tool (the scanner) in a previous layer.

The layer in which the precorrection is implemented may be an uncritical layer in the sense that the overlay requirements of that layer with respect to a prior layer are not negatively affected by the precorrection.

Embodiments of the invention thus correct in a previous layer asymmetric field magnification and/or asymmetric field rotation and possibly further field parameters such as third order distortion that cannot be corrected in the present layer. For example, if the top layer patterns are produced using a stepper that is not able to correct asymmetric field errors, appropriate biases are fed to a previous scanner layer to precorrect such field errors. The precorrection may be implemented on the basis of control signals produced by an advanced process control system.

Further explanations and embodiments of the invention are reduced to the ten parameter model discussed above. The skilled person will realize, however, that embodiments of the invention may be implemented with respect to other field parameters as well.

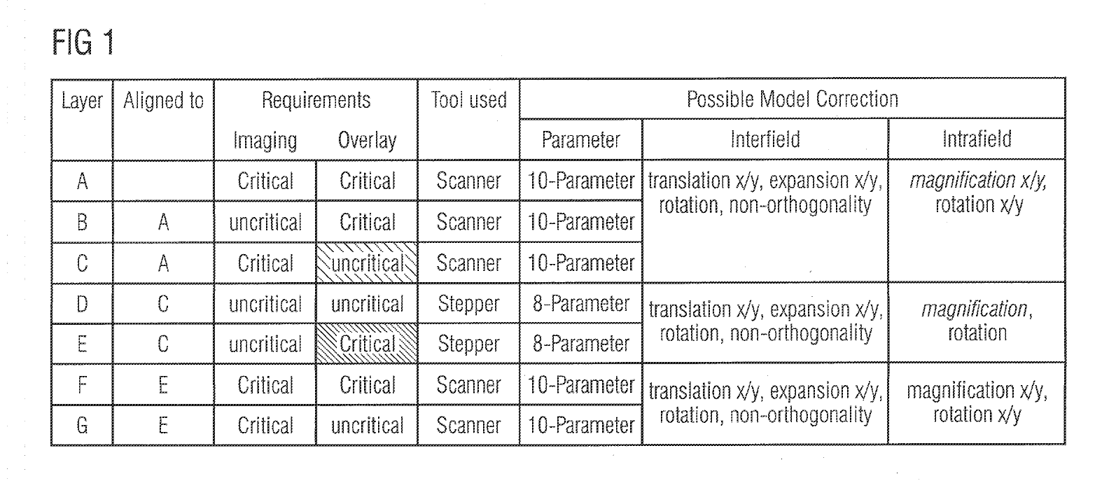

FIG. 1 shows an example of a simplified process layer sequence with an indication of the layer requirements, the used lithographic tools, alignment levels and possible overlay correction parameters. The first column denotes the involved layer. In this example, there are seven layers A to G. The second column denotes to which layer the layer indicated in the first column is aligned. For example, layer C is aligned to layer A and layer E is aligned to layer C.

The third column denotes requirements as to imaging and overlay. “Imaging” refers to the size of the structures to be formed in the respective layer. The smallest structure that can be implemented is known as the critical dimension. The “imaging” requirement may be critical or uncritical. If the imaging requirement is uncritical, the use of a stepper is sufficient for producing a desired pattern in a respective layer. If the imaging requirement is critical, the use of a scanner is required for producing a desired pattern in a respective layer. As discussed above, a scanner allows for production of smaller features.

The other requirement regards overlay, i.e., the alignment of patterns produced by exposure fields of two different layers. The overlay requirement may also be critical or uncritical. For example, the overlay requirement may be uncritical if there is a large overlay budget, for example due to relatively large structures on the two layers that need to be aligned with respect to each other.

The fourth column identifies the tool that is used to form an image of a reticle pattern on a photoresist of the respective layer. The tool is either a scanner or a stepper.

The fifth column includes three subcolumns. The first subcolumn identifies the number of parameters that may be corrected by the tool used. The number of parameters that may be corrected is either eight or ten. Eight parameters may be corrected by a stepper. Ten parameters may be corrected by a scanner. The second subcolumn identifies the interfield parameters that may be corrected. These are translation x/y, expansion x/y, rotation and non-orthogonality. These parameters may be corrected both by a scanner and a stepper. The third subcolumn identifies the intrafield parameters. When a scanner is used, the additional parameters are magnification x/y and rotation x/y. If a stepper is used, the intrafield parameters which may be corrected are field magnification and field rotation, without the ability to correct asymmetric field magnification and asymmetric field rotation.

In the example shown in FIG. 1, layer E is aligned to layer C. The overlay requirement of layer E is critical. On the other hand, the overlay requirement of layer C is uncritical. The stepper layer E with critical overlay is thus a follower of the scanner layer C with uncritical overlay.

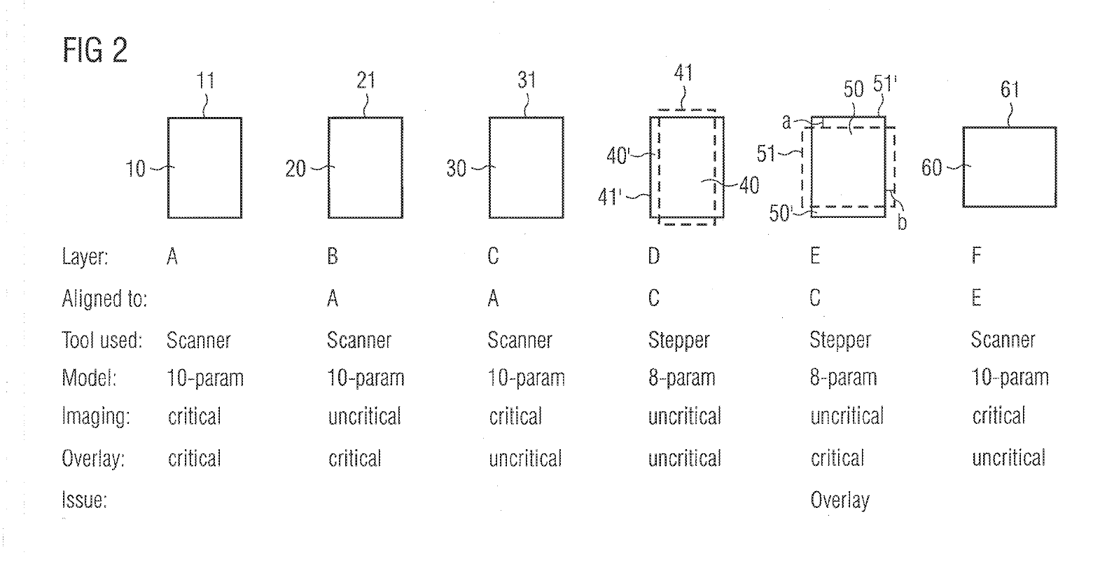

This may lead to problems as can be seen in FIG. 2. FIG. 2 corresponds to FIG. 1 but additionally schematically depicts in the first row the exposure field of the scanner or stepper that is used to produce a pattern in the respective layer.

More particularly, the first row schematically shows the dimension of an exposure field that is produced when a scanner or stepper forms an image of a reticle pattern on a photoresist of the respective layer. As is well known to those skilled in the art and not discussed in detail, such a photoresist pattern is transferred by etching into the respective layer of a semiconductor substrate such as a wafer. Further process steps such as ion implantation may follow. The wafer is then cleaned and recoated with photoresist for providing a pattern in a further layer. In this manner, a circuit is created layer-by-layer.

It is pointed out that, as an exposure field forms a specific pattern in a specific layer, field errors of the exposure field, such as asymmetric magnification or asymmetric rotation, directly translate into the respective pattern. Also, the outline and dimensions of the exposure field determine the outline and dimensions of the respective pattern.

The second row of FIG. 2 identifies the layer. The third row identifies the layer to which the respective layer is aligned. The fourth row identifies the type of tool used, i.e., scanner or stepper. The fifth row identifies if the ten parameter model or the eight parameter model applies. The sixth row identifies if the imaging requirement is critical or uncritical. The seventh row identifies if the overlay requirement is critical or uncritical. The eighth row identifies the critical issue if there is one.

Looking at the first row of FIG. 2, the exposure fields 10, 20, 30 of layers A to C have an outline 11, 21, 31. It is noted that there is no overlay between the exposure fields 10, 20, 30 of layers A to C. This is because any overlay of the exposure fields of layers B and C with respect to layer A could be corrected by the scanner such that the exposure fields 10, 20, 30 and corresponding patterns of layers A, B and C are on top of each other.

The outline of exposure field 40 of layer D, which is produced by a stepper, is identified by dotted lines 41. The outline of the pattern 40′ produced by exposure field 30 of layer C is depicted as outline 41′. Exposure field 40 is compressed in the horizontal direction compared to pattern 40′ (and the exposure fields 10, 20, 30 of layers A, B, C).

The outline of exposure field 50 of layer E, which is also produced by a stepper, is identified by dotted lines 51. The outline of the pattern 50′ produced by exposure field 30 of layer C is depicted as outline 51′, layer C being the layer to which layer E is to be aligned. Exposure field 50 is compressed in the vertical direction compared to pattern 50′ (and the exposure fields 10, 20, 30 of layers A, B, C). The displacement in the x- and y-directions is identified as a, b. The displacement a, b is asymmetric and corresponds to an inherent asymmetric field magnification produced by the used stepper.

The outline 61 of exposure field 60 of layer F corresponds to the pattern produced by exposure field 50 of layer E as the tool used for layer F is a scanner that can correct the field parameters of exposure field 60 accordingly.

Accordingly, there remains a mismatch from layer D to layer C and from layer E to layer C. In the example of FIG. 2, the mismatch from layer D to layer C is uncritical as the overlay requirement is uncritical. However, in layer E the overlay requirement is critical such that there remains an unresolved overlay issue.

In such a situation, conventionally, a scanner would be used for layer E replacing the stepper or the front glasses of the stepper lenses would be replaced to minimize the asymmetric field magnification.

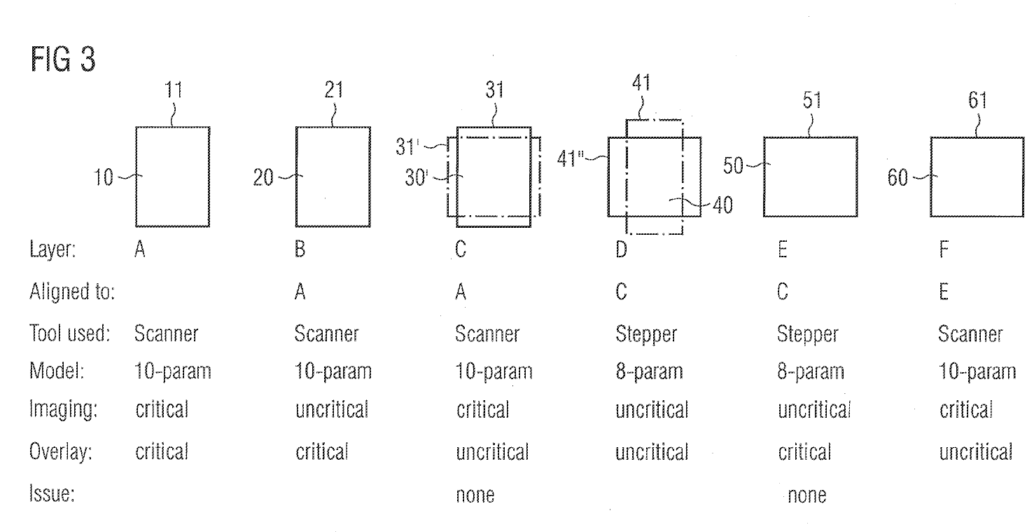

FIG. 3 shows in an exemplary embodiment a precorrection scenario that avoids the replacement of a stepper system by a scanner system or a manipulation of the lens system of the stepper system in a situation as described by example with respect to FIG. 2. To this end, the asymmetric field parameters that cannot be corrected by the stepper of layer E are precorrected by the scanner of layer C, which is the more powerful tool and is able to correct these parameters. Accordingly, the field parameters of scanner layer C, the overlay requirement of which is uncritical, are precorrected in such a way that that the overlay issue is resolved, i.e., the overlay between the pattern produced by the exposure field of layer C and the pattern produced by the exposure field of the stepper of layer E is minimized or reduced.

More particularly, according to FIG. 3, the exposure field 30′ of layer C, the outline of which is depicted by a dot and dash line 31′, is intentionally compressed by the scanner system in the y-direction compared to the uncompressed field with boundary 31 (see FIG. 2). It is noted that this does not lead to an unwanted overlay problem with respect to layer A, to which layer C is to be aligned, as the overlay requirement of layer C is uncritical, i.e., the overlay budget with respect to layer A (and layer B) is sufficiently large to absorb the intentional biasing of the exposure field in layer C.

The intentional compression of the exposure field 30′ in the y-direction is an example of an asymmetric field magnification that is implemented as a precorrection in layer C. By precorrecting the field of layer C, in layer E the overlay to layer C is now minimized. The outline 51 of exposure field 50 matches with the outline 31′ of precorrected exposure field 30′ such that the respective exposure fields and corresponding patterns are on top of each other. The overlay issue has been resolved.

Regarding layer D, it is noted that because of the compression in y-direction of the exposure field 30′ of layer C, the mismatch between the exposure field 40 of layer D, the outline of which is depicted by dot and dash line 41, and the exposure field 31′ of layer C and corresponding pattern 41 ″ of layer D is even larger than in FIG. 2. However, as the overlay requirement is uncritical between layers D and C, this does not lead to problems. Also, in other embodiments there may not be a layer between the layers which needs to be matched in view of a critical overlay issue.

The above embodiment is to be understood as an example only. For example, a precorrection may be implemented in other layers such as layers A or B. Also, the precorrection of FIG. 3 regards the field magnification parameter. Similarly, the field rotation parameter could be precorrected or any other field parameter such as a third order distortion or linear rotation.

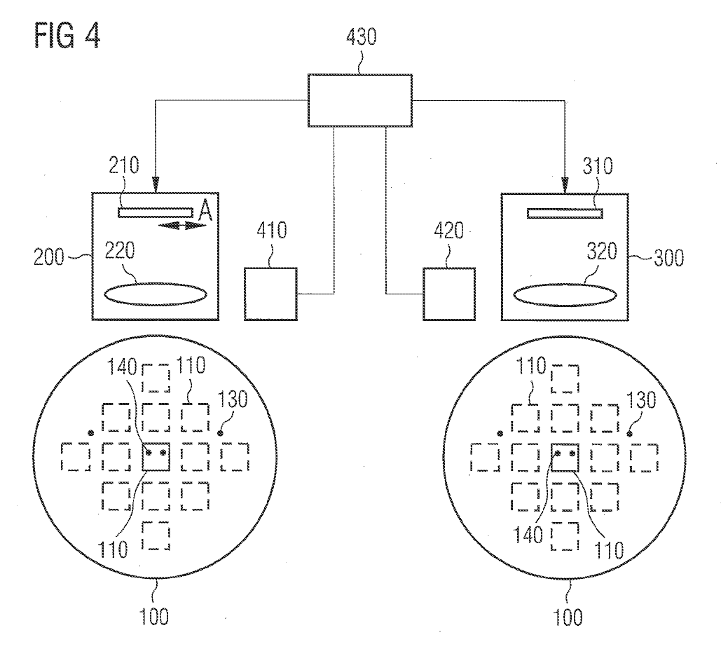

FIG. 4 schematically shows an apparatus for the manufacturing of semiconductor devices which includes a scanner system 200, a stepper system 300, control apparatus 410, 420, 430 and a wafer 100.

The wafer 100 is depicted in FIG. 4 in two positions. In the first, left hand position the wafer 100 is associated with the scanner system 200. In the second, right hand position the wafer 100 is associated with the stepper system 300. When producing a photolithographic pattern in a layer of wafer 100, the wafer 100 is either associated with the scanner system 200 or the stepper system 300.

The wafer 100 is part of a wafer stage and is located on a wafer chuck (not shown) as is well known to those skilled in the art. The wafer 100 includes a plurality of individual fields 110 that, when the manufacturing of the wafer 100 is completed, each form an individual die or chip. The fields 110 correspond to exposure fields exposed in turn by the scanner system 200 or the stepper system 300. In FIG. 4, the field 110 which is presently exposed with light of scanner system 200 or stepper system 300 is depicted in solid lines, while the fields 110 presently not exposed are depicted in dashed lines.

The wafer 100 and the fields 110 further comprise alignment markers 130, 140.

The scanner system 200 includes a reticle 210 that is held in a reticle stage and is movable relative to the wafer 100 as is indicated by arrow A. The scanner system 200 further comprises a projection lens system 220 that serves to provide on a photoresist of the wafer 100 an exposure field which is an image of the pattern of reticle 210. The scanner system 200, instead of exposing an entire exposure field 110 at once, provides for an exposure slit which has only a fraction of the length of the exposure field 110. The image from the exposure slit is scanned across the exposure field 110. This is achieved by a precisely synchronized relative movement between the reticle stage and the wafer stage during exposure as is well known to those skilled in the art.

Stepper system 300 also includes a reticle 310 and a projection lens system 320. Different than the scanner system 200, the stepper system 300 at once projects a pattern of the reticle 310 on a field 110.

It is noted that the schematic representation of FIG. 4 does not discriminate between patterns of a field 110 previously produced in layers of the wafer 100 which are below the top layer and an actual exposure field provided on a photoresist on the top layer of the wafer 100. As the exposure field provided on the photoresist determines the pattern of the new layer to be formed, the light pattern which is projected on the photoresist must be aligned exactly with the already existing structures and patterns in fields 110.

Both the scanner system 200 and the stepper system 300 to this end each include a control apparatus 410, 420, respectively. The control apparatus 410, 420 serve to measure the location of alignment markers 130, 140, e.g., by edge detection or other methods known to the skilled person. The information regarding the location of alignment markers 130, 140 may be delivered from apparatus 410, 420 to an advanced process control device 430 which includes a feedback loop to provide for an exact alignment of an exposure field 110 with respect to a previous pattern of the respective field.

More particularly, alignment markers 130, 140 serve to provide an overlay control with respect to interfield parameters. The interfield parameters may be adjusted by an adjustment apparatus (not shown) which is configured to adjust the wafer 100 and/or the scanner system 200 or stepper system 300 in all three dimensions and/or to control the temperature of the wafer 100. A first adjustment regarding the complete wafer 100 may be provided by adjustment markers 130. A second, finer adjustment may be provided for each field 110 by means of adjustment markers 140 placed in fields 110. Known techniques such as box-in-box structures may be used to determine an offset and mismatch between patterns of different layers.

However, a three-dimensional adjustment in position and/or a temperature control of the wafer can provide for the correction of interfield parameters only.

Intrafield parameters need to be corrected by the scanner system 200 or stepper system 300, with the stepper system 300 being able to correct symmetric field parameters only, while the scanner system 200 also may correct asymmetric field parameters as discussed above.

To implement a precorrection as discussed above, the control apparatus 410, 420 also determine the field parameters. More particularly, control apparatus 420 directly or indirectly detects the exposure field of the stepper system 300 and any asymmetric components this exposure field may inherently have. This may be done, e.g., in a test run in which the structures produced by the stepper field are determined by metrology tools. More particularly, the structures which are produced by the stepper field may be compared to structures of a previous layer to which the actual layer shall be aligned. This may be done using, e.g., box-in-box structures. The displacement between the layers measured by the metrology tools indicates the exposure field of the stepper system 300 and its asymmetric field parameters.

The acquired information is given to advanced process control device 430 which uses this information for a precorrection by providing appropriate control signals to scanner system 200.

For example, the scanner system 200 may be set to adapt the operation of the scanner to precorrect the mismatch. For example, the synchronization between the moving wafer and the reticle stages may be changed during exposure. Also, as the optical properties of the projection lens system 210 of the scanner system 200 can be optimized during exposure, the advanced process control system 430 may set the scanner system 200 to precorrect a mismatch by changing at least one parameter of the projection lens system 220. For example, the lens system 220 could be completely or partially blurred or clouded.

It is pointed out that control apparatus 410, 420 need not be individual devices but may be integrated in scanner system 200 and stepper system 300.

The above embodiments are examples for a precorrection of uncritical layers during semiconductor manufacture. However, the invention is not limited to these embodiments. For example, a precorrection may be implemented for other reasons than the limited capabilities of a stepper to correct field parameters. Also, a precorrection may be applied in other lithographic techniques such as electron beam lithography and X-ray lithography.

What is claimed is:

1. A method of manufacturing a semiconductor device, the method comprising:
providing a semiconductor substrate;
producing a first photolithographic pattern in a first layer of the semiconductor substrate, the producing of the first photolithographic pattern comprising:
providing a first photoresist on the first layer; and
providing a first exposure field on the first photoresist by means of a first apparatus, the first exposure field being imaged from a first reticle pattern;
producing a second photolithographic pattern in a second layer of the semiconductor substrate, the producing of the second photolithographic pattern comprising:
providing a second photoresist on the second layer; and
providing a second exposure field on the second photoresist by means of a second apparatus, the second exposure field being imaged from a second reticle pattern;
matching the first reticle pattern and the second reticle pattern, the matching comprising:
determining a mismatch between the first reticle pattern and the second reticle pattern that would occur without the matching; and
precorrecting the determined mismatch in the first layer.

2. The method according to claim 1, wherein precorrecting the determined mismatch in the first layer comprises providing an asymmetric field magnification of the first exposure field.

3. The method according to claim 1, wherein precorrecting the determined mismatch in the first layer comprises providing an asymmetric field rotation of the first exposure field.

4. The method according to claim 1, wherein precorrecting the determined mismatch in the first layer comprises providing a third order distortion of the first exposure field.

5. The method according to claim 1, wherein precorrecting the determined mismatch in the first layer comprises biasing the first exposure field dependent on the determined mismatch.

6. The method according to claim 1, wherein precorrecting the determined mismatch in the first layer comprises correcting at least one field parameter of the first exposure field such that an overlay between the first and the second reticle patterns is minimized or reduced.

7. The method according to claim 1, wherein determining the mismatch between the first reticle pattern and the second reticle pattern comprises calculating or measuring the mismatch.

8. The method according to claim 1, wherein an area exposed by the first and the second exposure fields corresponds to a die formed in the semiconductor substrate.

9. The method according to claim 1, wherein the first apparatus is able to correct a larger number of parameters of an exposure field than the second apparatus.

10. The method according to claim 1, wherein the first exposure field is provided by means of a scanner system and the second exposure field is provided by means of a stepper system.

11. The method according to claim 1, wherein the first reticle pattern is uncritical in the sense that there exists an overlay budget when matching the first reticle pattern to a pattern of a previous layer.

12. A method of manufacturing a semiconductor device, the method comprising:
providing a semiconductor substrate;
producing a first pattern in a first layer of the semiconductor substrate;
producing a second pattern in a second layer of the semiconductor substrate;
determining a mismatch between the first pattern and the second pattern that would occur without matching the first pattern and the second pattern; and
precorrecting the determined mismatch in the first layer.

13. The method of claim 12, wherein precorrecting the determined mismatch in the first layer comprises correcting at least one field parameter of an exposure field used to produce the first pattern in the first layer.

14. A method of manufacturing a semiconductor device, the method comprising:
providing a semiconductor substrate;
producing a first photolithographic pattern in a first layer of the semiconductor substrate, the producing of the first photolithographic pattern comprising:
providing a first photoresist on the first layer; and
providing a first exposure field on the first photoresist by means of a scanner system, the first exposure field being imaged from a first reticle pattern, the first exposure field comprising at least one field parameter;
producing a second photolithographic pattern in a second layer of the semiconductor substrate, the producing of the second photolithographic pattern comprising:
providing a second photoresist on the second layer; and
providing a second exposure field on the second photoresist by means of a stepper system, the second exposure field being imaged from a second reticle pattern;
matching the first reticle pattern and the second reticle pattern, the matching comprising:
determining a mismatch between the first reticle pattern and the second reticle pattern that would occur without the matching; and
precorrecting the determined mismatch in the first layer by setting the scanner system to provide for at least one of an asymmetric field magnification, an asymmetric field rotation and a third order distortion of the first exposure field.

15. The method according to claim 14, wherein the scanner system is adapted to provide for the at least one of the asymmetric field magnification, the asymmetric field rotation and the third order distortion of the first exposure field in such a way that a pattern produced in the first layer by the precorrected first exposure field matches with the second exposure field provided by the stepper system.

16. The method according to claim 14, wherein precorrecting the determined mismatch in the first layer comprises adapting operation of the scanner system to precorrect the determined mismatch.

17. The method according to claim 14, wherein the scanner system comprises a projection lens system and precorrecting the determined mismatch in the first layer comprises changing at least one parameter of the projection lens system.

18. An apparatus for the manufacturing of semiconductor devices, the apparatus comprising:
a scanner system configured to provide a first exposure field on a first photoresist of a first layer of a semiconductor substrate, the first exposure field being imaged from a first reticle pattern;
a stepper system configured to provide a second exposure field on a second photoresist of a second layer of the semiconductor substrate, the second exposure field being imaged from a second reticle pattern; and
a control apparatus configured to determine a mismatch between a first photolithographic pattern produced using the first exposure field and a second pattern provided by the second exposure field,
wherein the scanner system is adapted to precorrect the determined mismatch in the first layer such that an overlay of a pattern produced in the first layer after precorrection of the determined mismatch and the second pattern provided by the second exposure field is minimized or reduced.

19. The apparatus according to claim 18, wherein the scanner system is adapted to precorrect the determined mismatch in the first layer by providing an asymmetric field magnification of the first exposure field.

20. The apparatus according to claim 18, wherein the scanner system is adapted to precorrect the determined mismatch in the first layer by providing an asymmetric field rotation of the first exposure field.

21. The apparatus according to claim 18, wherein the scanner system is adapted to precorrect the determined mismatch in the first layer by providing a third order distortion of the first exposure field.

22. The apparatus according to claim 18, wherein the control apparatus is part of an advanced process control system.

23. An apparatus for the manufacturing of semiconductor devices, the apparatus comprising:
means for producing a first pattern in a first layer of a semiconductor substrate;
means for producing a second pattern in a second layer of the semiconductor substrate;
means for determining a mismatch between the first pattern and the second pattern that would occur without matching the first pattern and the second pattern; and
means for precorrecting the determined mismatch in the first layer.

24. The apparatus according to claim 23, wherein the means for precorrecting the determined mismatch in the first layer comprise means for correcting at least one field parameter of an exposure field used to produce the first pattern in the first layer.

25. The apparatus according to claim 24, wherein the at least one field parameter comprises at least one of an asymmetric field magnification, an asymmetric field rotation and a third order distortion of the exposure field.
